(19) United States
(12) Patent Application Publication
(10) Pub. No.: US 2025/0240857 A1
(43) Pub. Date: Jul. 24, 2025

(54) LIGHTING SYSTEM

(71) Applicant: Robert Joseph Kaminsky, JR., Homer Glen, IL (US)

(72) Inventor: Robert Joseph Kaminsky, JR., Homer Glen, IL (US)

(21) Appl. No.: 18/421,120

(22) Filed: Jan. 24, 2024

(51) Int. Cl. H05B 47/155; F21V 23/04; F21V 23/06

(52) U.S. Cl. CPC H05B 47/155; F21V 23/0414; F21V 23/06

(57) ABSTRACT

A lighting system has: a light generating unit with a first illumination source and a second illumination source; a first power supply; a second power supply; a first switch; and a second switch. The first switch is selectively changeable between different states to thereby change an amount of current flowing from the first power supply to the first illumination source. The second switch is selectively changeable between different states to thereby change an amount of current flowing from the second power supply to the second illumination source.

### BACKGROUND OF THE INVENTION

### Field of the Invention

This invention relates to lighting systems as used in homes and businesses and, more particularly, to a lighting system with a light generating unit that can be controlled selectively from different locations.

### Background Art

In homes and businesses worldwide, light generating units designed to illuminate a discrete space are commonly utilized. Without limitation, these light generating units, as in the exemplary form of self-contained “lamps”, may be portable in nature and used on desks, on nightstands adjacent to beds, on dressers, etc., or integrated into structural features on buildings.

These light generating units are controlled in many different manners. For example, a light generating unit on a nightstand may have an associated switch/rheostat through which a user may selectively turn an illumination source thereon “on” and “off”, or change the intensity of generated light through a range. It is common for switches to be mounted directly upon a rigid portion of the light generating unit or on a power supply line.

It is also known to control the light generating unit through a switch that controls an electrical outlet into which a line/cord is plugged to couple power to the illumination source(s).

In one form, an electrical outlet may have one or two receptacles that are controlled by a remote switch. In one configuration for a two receptacle electrical outlet, both receptacles are controlled by the switch. Alternatively, only one of the receptacles is controlled by the switch whereby the other receptacle remains “live.”

When multiple switches are provided to control a single illumination source, coordination issues arise. For example, in a bedroom, a user may wish to have an operating switch accessible upon entry into the room to control a receptacle into which a light generating unit, as on a nightstand, is electrically connected. If the entry switch is turned on, and there is a separate switch associated with the illumination source, the user can leave the entry switch on and turn the switch on the illumination source off, as when going to sleep. However, with the entry switch off, a user is unable to turn the illumination source on through the switch associated with the illumination source—be it on a rigid part of the illumination source and/or a line/cord connected to the power supply. In the event that the switch associated with the illumination source is off, a user entering the room cannot turn the illumination source on using the entry switch.

In the event that a user wakes in the middle of the night with the entry switch off, he/she is unable to turn the illumination source on without crossing the room to access the entry switch.

Accordingly, steps must be taken and routines established to make certain that the switches are coordinated appropriately so that users do not experience any inconvenience, particularly in a darkened room where a user may be required to navigate over a significant distance towards the entry switch to allow the illumination source to be turned on.

The present invention is directed to addressing issues as discussed above.

### SUMMARY OF THE INVENTION

In one form, the invention is directed to a lighting system having: a light generating unit with a first illumination source and a second illumination source; a first power supply; a second power supply; a first switch; and a second switch. The first switch is selectively changeable between different states to thereby change an amount of current flowing from the first power supply to the first illumination source. The second switch is selectively changeable between different states to thereby change an amount of current flowing from the second power supply to the second illumination source

In one form, in one of the different states for the first switch, there is no current flowing from the first power supply to the first illumination source.

In one form, in one of the different states for the second switch, there is no current flowing from the second power supply to the second illumination source.

In one form, the first and second illumination sources each has a light generating component that is one of: a) a filament; b) a semiconductor; and c) a gas that generates light when supplied current from one of the first and second power supplies.

In one form, the first illumination source has a first bulb within which at least one light generating component is located and the second illumination source has a second bulb within which at least one light generating component is located.

In one form, with the first switch in a second of the different states for the first switch, current flowing from the first power supply causes the first illumination source to generate light. With the second switch in a second of the different states for the second switch, current flowing from the second power supply causes the second illumination source to generate light.

In one form, at least one of the first and second switches is spaced from the light generating unit.

In one form, the light generating unit has a first supply line for supplying power from the first power supply to the first illumination source.

In one form, the first supply line is electrically connected to the first power supply. The first switch is configured so that in first and second of the different states for the first switch, different current is supplied from the first power source to the first illumination source.

In one form, the light generating unit has a second supply line for supplying power from the second power supply to the second illumination source.

In one form, the second supply line is electrically connected to the second power supply. The second switch is configured so that in first and second of the different states for the second switch, different current is supplied from the second power source to the second illumination source.

In one form, the light generating unit is configured to be portable and movable as one piece to be placed in different operative positions.

In one form, the lighting system has a single bulb within which a light generating component on each of the first and second illumination sources is located.

In one form, there is a first connector associated with the first power supply. The first supply line has a connector that is releasably connectable to the first connector to electrically connect the first supply line to the first power supply.

In one form, the first switch is spaced from the first connector.

In one form, the first connector is part of an electrical outlet at a wall surface of a room in which the light generating unit is placed in an operative position.

In one form, with the first supply line connector connected to the first power supply connector and the switch in one of the different states for the first switch, no current flows from the first power supply to the first illumination source. With the first supply line connector connected to the first power supply connector and the switch in another of the different states for the first switch, current flows from the first power supply to the first illumination source, as an incident of which light is generated by the first illumination source.

In one form, one of the first and second switches is on the light generating unit.

In one form, the first and second switches are not electrically connected to each other.

In one form, the first and second power supplies originate from one of: a) a shared power line; and b) power lines on separate circuits.

### BRIEF DESCRIPTION OF THE DRAWINGS

FIG. 1 is a schematic representation of a lighting system, according to the present invention, and including first and second illumination sources that independently generate light;

FIG. 2 is a schematic representation of different potential light generating components for each of the illumination sources in FIG. 1;

FIG. 3 is a schematic representation showing additional details of each of the illumination sources, with each illumination source having a bulb with at least one light generating component;

FIG. 4 is a schematic representation corresponding to that in FIG. 3, wherein a single bulb contains light generating components for both illumination sources;

FIG. 5 is a schematic representation showing additional details of a connection between the first illumination source and first power supply with control through the first switch of FIG. 1;

FIG. 6 is a schematic representation corresponding to that in FIG. 5 with corresponding parts associated with the second illumination source in FIG. 1;

FIG. 7 is a schematic representation showing connectors between a representative first supply line/cord, as shown in FIG. 5, and the first power supply of FIG. 1;

FIG. 8 is a schematic representation of an electrical outlet with the connector for the first power supply as shown in FIG. 7;

FIG. 9 is a schematic depiction of a portion of a room in which one form of the light generating unit, as shown in FIG. 1, is incorporated; and

FIG. 10 is a partially schematic representation of a conventional electrical outlet, as shown schematically in FIG. 8, with independent connectors to two separate power supplies from a common power line.

### DETAILED DESCRIPTION OF THE PREFERRED EMBODIMENT

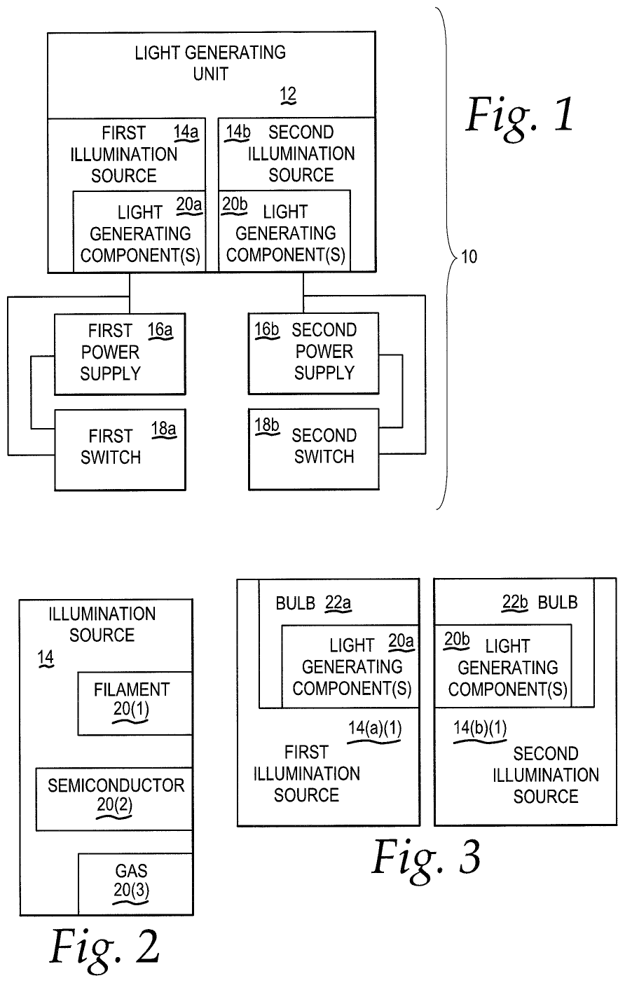

In one form, as shown schematically in FIG. 1, a lighting system 10, according to the present invention, consists of a light generating unit 12 consisting of at least first and second illumination sources 14a, 14b, first and second power supplies 16a, 16b, respectively, and first and second switches 18a, 18b, respectively.

The first switch 18a is selectively changeable between different states to thereby change an amount of current flowing from the first power supply 16a to the first illumination source 14a.

The second switch 18b is selectively changeable between different states to thereby change an amount of current flowing from the second power supply 16b to the second illumination source 14b.

As depicted, the switches 18a, 18b may be operated to control generation of current by the first and second power supplies 16a, 16b, or by controlling current in the electrical path away from the respective power supplies 16a, 16b.

The configuration of the switches 18 may be such that they have only two different states—on and off—or such that they function as rheostats to vary current flow over a prescribed range, including potentially no current flow.

The first and second illumination sources 14a, 14b each has at least one light generating component 20a, 20b, respectively.

The illumination source 14 may be any structure that generates light when supplied with an electrical current. As shown schematically in FIG. 2, as just examples, the illumination source 14 may have a light generating component 20 in the form of: a filament 20(1) as typically on an incandescent bulb; a semiconductor 20(2) as typically on an LED bulb; and a gas 20(3) as common in fluorescent type bulbs.

In one form, as shown in FIG. 3, the first illumination source 14a(1) consists of a bulb 22a within which at least one light generating component 20a is located. The second illumination source 14b(1) has a second bulb 22b within which at least one light generating component 20b is located.

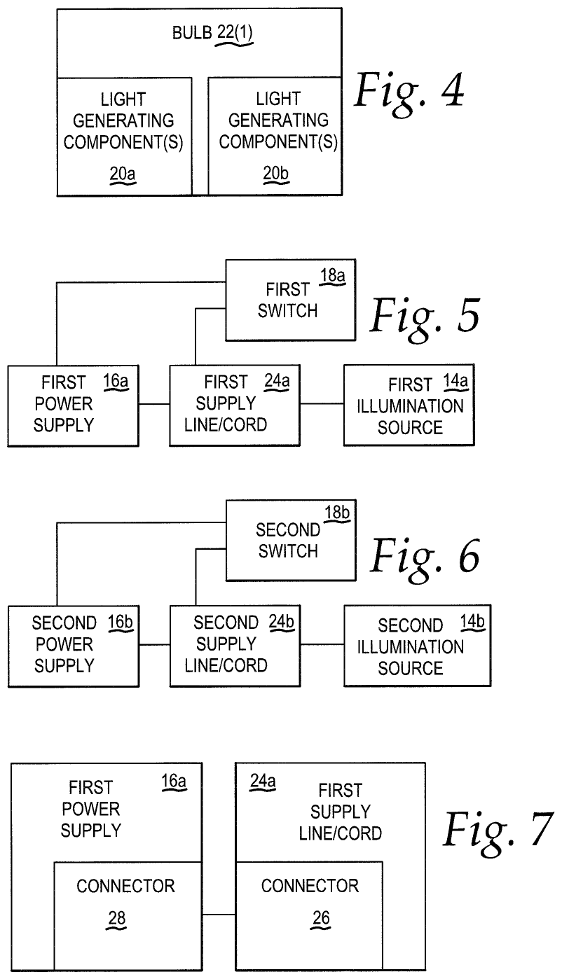

In an alternative form as shown in FIG. 4, the light generating components 20a, 20b associated with the first and second illumination sources 14a, 14b, respectively, may be contained within a single bulb 22(1).

As shown in FIG. 5, in one form, the light generating unit has a first supply line/cord 24a for supplying power from the first power supply 16a to the first illumination source 14a. The first supply line/cord 24a is electrically connected to the first power supply 16a.

The first switch 18a, as noted above, is constructed to have different states. The different states may be “on” and “off”, with current flow interrupted in the latter state. Alternatively, current flow may be controlled through the first switch 18a using a rheostat to change the intensity of light generated through the first illumination source 14a.

As seen in FIG. 5, the first switch 18a may control the state of the first power supply 16a and/or control current flow between the first power supply 16a and the first illumination source 14a.

In FIG. 6, a second supply line/cord 24b is shown electrically connecting between the second power supply 16b and the second illumination source 14b, thereby supplying power from the second power supply 16b to the second illumination source 14b.

The second supply line/cord 24b is similarly electrically connected to the second power supply 16b. The second switch 18b is configured so that, as noted above, current supplied to the second illumination source 14b is controlled. The second switch 18b may be an on/off switch or have a rheostat incorporated to control flow of current over a range to control intensity of light generated through the second illumination source 14b.

The second switch 18b may control current flow by controlling the second power supply 16b directly or by controlling current flow between the second power supply 16b and the second illumination source 14b.

The first supply line/cord 24a may be hardwired to the first power supply 16a.

Alternatively, as shown in FIG. 7, the first supply line/cord 24a may have a connector 26 that is releasably connected to a connector 28 associated with the first power supply 16a to thereby electrically connect the first supply line/cord 24a to the first power supply 16a.

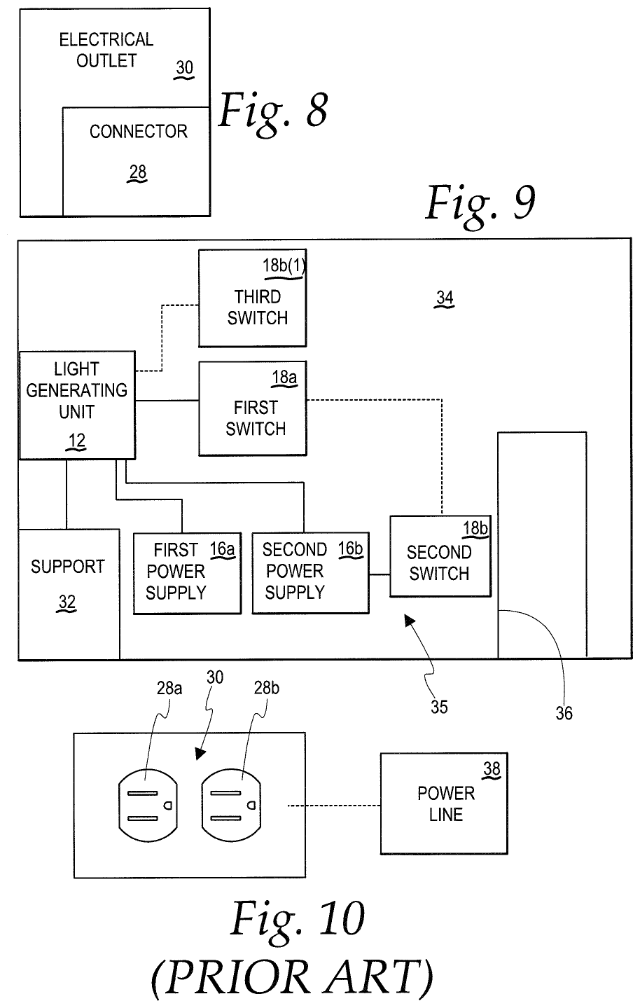

In one exemplary form, as shown in FIG. 8, the connector 28 is in the form of a receptacle on a conventional electrical outlet 30 as commonly used to plug in lamps, appliances, etc.

In FIG. 9, one exemplary system setup is depicted in primarily schematic form. As shown in FIG. 9, the light generating unit 12 schematically encompasses, without limitation, a configuration that is portable and movable as one piece to be placeable in different operative positions. The light generating unit 12 is shown placed on the top of a support 32 that may be, without limitation, a nightstand adjacent to a bed.

The unitary construction may alternatively be integrated into a structural feature, as on a building.

In FIG. 9, one wall 34 bounds a space/room 35 within which the support 32 is located. An entry opening 36 is formed through the wall 34.

The light generating unit 12 has the aforementioned first illumination source 14a and second illumination source 14b, as shown in FIG. 1, respectively electrically connected to the first power supply 16a and second power supply 16b.

The first and second power supplies 16a, 16b may be at separate electrical outlets or, as shown in FIG. 10, may be provided on a single electrical outlet 30 with a shared power line 38, with the separate power supplies being identified at the receptacles/connectors 28a, 28b. One of the connectors 28a, 28b may be controlled, as through the second switch 18b, while leaving the other power supply at 28a at all times “live.”

For purposes of explanation only, and without limitation, the first switch 18a will be described as being on the light generating unit 12, with it understood that the first switch 18a might also be connected directly to the first supply line/cord 24a or elsewhere. The first supply line/cord 24a may be considered to be a part of the light generating unit 12, or separate therefrom.

In FIG. 9, the first and second power supplies 16a, 16b will be considered as originating from power lines in separate circuits, rather than from a shared power line 38 as shown in FIG. 10.

As one operating example, with reference to FIG. 9, and utilizing exemplary switches 18 with only an on/off capability, the second switch 18b may be changed to its “on” state which causes the second illumination source 14b to generate light through its light generating component(s) 20b. It may be desirable, but it is not a requirement, to have the second illuminating source 14b generating light for general purpose within the room and to have the second switch 18b near the entry opening 36, either inside or outside of the room 35.

The occupant of the room can change the first switch 18a from its “off” state into its “on” state to cause the first illumination source 14a to generate light independently of the second illumination source 14b.

An optional third switch 18b(1) may be provided to turn off the second illumination source 146 independently of the second switch 18b.

The system may be constructed so that each of the first and second illumination sources 14a, 14b independently generates light.

In the event that the second switch 18b is in its “off” state, the occupant of the room has the ability to generate light through the first illumination source 14a. By providing the first switch 18a either on the light generating unit 12 or in adjacent relationship thereto, the occupant has the convenience of controlling the light generating unit 12, without limitation, from at, or adjacent, the bed location.

As depicted, the second switch 18b may be spaced a substantial distance away from the light generating unit 12, potentially even outside of the room which is accessed through the entryway 36.

Generally, there is no limitation as to where the switches 18a, 18b may be located and where the connection to the first and second power supplies 16a, 16b occurs.

In one form, with the depicted exemplary arrangement, the first and second switches 18a, 18b can at all times each be independently operated to selectively: a) cause light to be generated by its respective illumination source 14; and b) turn off or change the intensity of light generated by its respective illumination source.

Thus, in one form a user may at all times have the ability to turn on and off one of the illumination sources 14 through its respective switch 18, which switches 18 may be spaced a substantial distance away from each other.

As indicated in FIG. 9, the first and second switches 18a, 18b may be entirely independent or electrically connected to each other, as indicated in dotted lines.

In one typical, but not limiting, construction, the first and second supply lines/cords 24a, 24b each is in the form of a flexible wire/cord which is either hardwired to, or plugged into, a connector at its respective power supply 16a, 16b.

It should be noted that the reference to “first” and “second” is an arbitrary designation given only for purposes of simplifying description. For example, the first switch 18a and second switch 18b may be interchanged from the depicted arrangement.

It should also be understood that the schematic depictions of all components and their interactions are intended to encompass virtually an unlimited number of different variations of each of the components and their interactions.

Substantial flexibility in terms of system layouts is contemplated by interchanging features and parts, as schematically depicted.

The foregoing disclosure of specific embodiments is intended to be illustrative of the broad concepts comprehended by the invention.

1. A lighting system comprising:
a light generating unit comprising a first illumination source and a second illumination source;
a first power supply;
a second power supply;
a first switch; and
a second switch,
the first switch selectively changeable between different states to thereby change an amount of current flowing from the first power supply to the first illumination source,
the second switch selectively changeable between different states to thereby change an amount of current flowing from the second power supply to the second illumination source.

2. The lighting system according to claim 1 wherein in one of the different states for the first switch, there is no current flowing from the first power supply to the first illumination source.

3. The lighting system according to claim 2 wherein in one of the different states for the second switch, there is no current flowing from the second power supply to the second illumination source.

4. The lighting system according to claim 1 wherein the first and second illumination sources each comprises a light generating component that is one of: a) a filament; b) a semiconductor; and c) a gas that generates light when supplied current from one of the first and second power supplies.

5. The lighting system according to claim 1 wherein the first illumination source comprises a first bulb within which at least one light generating component is located and the second illumination source comprises a second bulb within which at least one light generating component is located.

6. The lighting system according to claim 3 wherein with the first switch in a second of the different states for the first switch current flowing from the first power supply causes the first illumination source to generate light and with the second switch in a second of the different states for the second switch current flowing from the second power supply causes the second illumination source to generate light.

7. The lighting system according to claim 6 wherein at least one of the first and second switches is spaced from the light generating unit.

8. The lighting system according to claim 1 wherein the light generating unit comprises a first supply line for supplying power from the first power supply to the first illumination source.

9. The lighting system according to claim 8 wherein the first supply line is electrically connected to the first power supply and the first switch is configured so that in first and second of the different states for the first switch, different current is supplied from the first power source to the first illumination source.

10. The lighting system according to claim 9 wherein the light generating unit comprises a second supply line for supplying power from the second power supply to the second illumination source.

11. The lighting system according to claim 10 wherein the second supply line is electrically connected to the second power supply and the second switch is configured so that in first and second of the different states for the second switch, different current is supplied from the second power source to the second illumination source.

12. The lighting system according to claim 1 wherein the light generating unit is configured to be portable and movable as one piece to be placed in different operative positions.

13. The lighting system according to claim 1 wherein the lighting system comprises a single bulb within which a light generating component on each of the first and second illumination sources is located.

14. The lighting system according to claim 8 wherein there is a first connector associated with the first power supply and the first supply line has a connector that is releasably connectable to the first connector to electrically connect the first supply line to the first power supply.

15. The lighting system according to claim 14 wherein the first switch is spaced from the first connector.

16. The lighting system according to claim 15 wherein the first connector is part of an electrical outlet at a wall surface of a room in which the light generating unit is placed in an operative position.

17. The lighting system according to claim 16 wherein: a) with the first supply line connector connected to the first power supply connector and the switch in one of the different states for the first switch, no current flows from the first power supply to the first illumination source; and b) with the first supply line connector connected to the first power supply connector and the switch in another of the different states for the first switch, current flows from the first power supply to the first illumination source as an incident of which light is generated by the first illumination source.

18. The lighting system according to claim 1 wherein one of the first and second switches is on the light generating unit.

19. The lighting system according to claim 1 wherein the first and second switches are not electrically connected to each other.

20. The lighting system according to claim 1 wherein the first and second power supplies originate from one of: a) a shared power line; and b) power lines on separate circuits.
